(19) United States
(12) Patent Application Publication
(10) Pub. No.: US 2016/0106043 A1
(43) Pub. Date: Apr. 21, 2016

(54) Bouquet Holder Apparatus and Method of Use

(71) Applicants: Poppy F. Eiler, Cranberry Twp., PA (US); James A. Eiler, Cranberry Twp., PA (US)

(72) Inventors: Poppy F. Eiler, Cranberry Twp., PA (US); James A. Eiler, Cranberry Twp., PA (US)

(21) Appl. No.: 14/839,941

(22) Filed: Aug. 29, 2015

Related U.S. Application Data
(60) Provisional application No. 62/045,142, filed on Sep. 3, 2014.

(51) Int. Cl. A01G 5/00

(52) U.S. Cl. CPC A01G 5/00

(57) ABSTRACT

A reusable flower bouquet arranging apparatus is presented for creating a hand-held bouquet with a hand tied appearance as would be used for a wedding bouquet or nosegay. Made from plastic with a plurality of spaced apart apertures, it can be used to make arrangements having an overall shape that is domed, cascading, crescent-shaped, heart-shaped, oval or several other configurations.

### CROSS-REFERENCE TO RELATED APPLICATION

This is a perfection of Provisional Application No. 62/045,142, filed on Sep. 3, 2014, the disclosure of which is fully incorporated by reference herein.

### BACKGROUND OF THE INVENTION

1. Field of the Invention

This invention relates to an apparatus for quickly and easily manipulating flowers into evenly distributed patterns to create a flower bouquet of a specific size and shape. This apparatus joins a plurality of flower stems into a tube to form the bouquet handle resulting in a three-dimensional bouquet where each flower is situated in a fixed position and at a proper height. The invention achieves a well-balanced, aesthetically pleasing flower bouquet with repeatable end use assembly.

The apparatus allows for changes to be made to a bouquet after initial assembly/formation so that new and/or replacement flowers can be inserted and then later removed. The apparatus can be used to create a flower bouquet with any type of material; fresh flowers and greenery, artificial flowers, or other products like jeweled brooches that are increasingly popular in flower bouquets. With predefined insertion points, this apparatus minimizes floral waste. And with its preferred dome, it makes bouquet assembly easy and quick. Furthermore, this device provides for the consistent assembly of bouquets, i.e., allowing for substantially the same bouquet to be constructed at two or more locations, thereby promoting greater arrangement duplication/consistency.

The apparatus of this invention is hemispherical, preferably dome-shaped, or of another similar three-dimensional configuration, any one of which has an enhanced outer edge for rigidity containing: a specified number of flexible apertures and specifically sized slits for flower insertion, a flexible tube handle to cover the flower stems, an optional flexible fluted tube handle collar placed above the flexible tube handle to aid in covering stems coming into the tube at an angle, and a stretchable fabric-like wrapper for the tube handle. Any dome shape and size can be manufactured and used to create the desired bouquet. The outer rim of that dome can be further enhanced with a plurality of smaller, simplified apertures into which may be inserted additional complimentary greenery if needed, or as desired.

2. Description of Relevant Art

Flower bouquet holders utilizing a foam head or a foam enclosed in a cage, with an integrated handle have been used extensively in the past. The use of these holders, however, requires some floral design experience and knowledge of the correct placement of flowers and greenery into that foam head for achieving a well-balanced, three-dimensional bouquet.

Various bouquet holders are known as shown and described in: Smithers U.S. Pat. No. 2,765,585, Hrivi U.S. Pat. No. 4,204,365, Hasty U.S. Pat. No. 5,070,644. Graham et al U.S. Pat. No. 5,454,189, Ghiotti U.S. Pat. No. 6,862,841 and Miller U.S. Pat. No. 7,310,910. Some disadvantages with the foregoing devices include: (1) the floral design experience needed to assure that flowers get placed in the correct positions for achieving a well balanced bouquet; (2) the foam area available is quite limited. So, after a flower is inserted into the foam, valuable space is taken up thus further limiting the amount of space remaining for additional flower stems; (3) if a designer removes a flower from the foam and inserts another flower therein, it is difficult to re-use the empty hole and assure that his/her replacement flower stem will remain secure in that foam base; (4) the foam head, with repeated insertions and occasional stem removals, begins to break down or disintegrate, thereby leading to flowers falling out from the arrangement prematurely. That, in turn, requires securing such flowers back in the assembled bouquet with wire or other fastening devices. Finally, (5) the aforementioned plastic handles are sometimes difficult to hold, especially for extended periods of time, and have been known to bend with heavier flower arrangements.

Although not for specific use as a hand-carried bride's bouquet, Matteucci U.S. Pat. No. 5,758,452 and the Fresh Flower Bouquet System of Foster Published U.S. patent application Ser. No. 11/217,416 (2006) utilize a vase or vessel grid-like cap, wherein flowers are inserted into grid holes. There are also problems with any flat grid system. They are two-dimensional, and require a more experienced, or professional, floral designer to arrange the flowers three-dimensionally therein. As such, they are not conducive towards assembling into a hand-held flower bouquet, let alone repeatable duplicative bouquets.

For traditional hand-tied bouquet methods that do not utilize a foam-type bouquet holder, the assembly of a flower bouquet is not straightforward and rather time-consuming. With or without a foam head device or grid, the assembly of any flower bouquet requires knowledge of: (1) floral design methodology in the selection of product, (2) the correct placement of flowers to achieve the desired result, and (3) the correct use of floral industry tools and supplies (such as picks, tapes, wires and the like) for properly securing a flower arrangement.

Use of these fastening products to create a hand-held flower bouquet is a time-consuming process because it must first be decided where to place the next flower. Each flower must then be fastened to the bouquet . . . one flower at a time.

### SUMMARY OF THE INVENTION

The present invention is an apparatus that quickly and easily creates a three-dimensional bouquet that is proportionally correct and well balanced with each flower duly secured into a fixed position and at the correct height.

Brides may request a bouquet of any size or shape. The device of this invention would likely be manufactured for accommodating at least three sizes. But for purposes of this disclosure, no specific dimensions are given as the bouquet size could vary, depending on latest trends, customer preference, different shapes that may come into style.

The apparatus, generally 10 includes a main holder 12 that is available in several configurations (round, tear-drop or other geometrical shape) and in varying sizes: 8-12″ for a typically round wedding bouquet or 6″ for a nosegay. Sometimes, the overall size of a flower arrangement may vary with the bride's desires, strength (i.e., ability to carry a heavier bouquet) and/or body shape (i.e., smaller arrangements for shorter or more petite framed brides). Still other potential shapes include a cascade, crescent, Hogarth (or S-curve), diagonal, heart, triangular (or pyramidal), oval or horizontal-shape with flowers flowing down from the arm or hand-held arrangement. The larger of these shapes, especially the oval and/or horizontal varieties, are suitable for use as table centerpieces. Each holder will contain a plurality of apertures (or slits) 20 for accepting flower stems F, usually one stem per aperture.

The apparatus includes a tube 60 and optional tube collar 30 for “housing” a plurality of flower stems F. The tube 60 and tube collar 30 are made of flexible plastic sheet rolled into the shapes shown. Slits 40 in the upper half of tube collar 30 permit its further expansion to provide additional coverage of stems F as they converge at a joining point.

The tube 60 and tube collar 30 may be manufactured from plastic or any other malleable material such as aluminum. Ideally, both may be bent (or hand-molded) to provide a more comfortable grip for the eventual bouquet carrier/holder. Tube 60 and tube collar 30 may also be manufactured in any color and/or texture (embossed). The tube 60 may be fully or partially encrusted with glued-on crystals, pearls, jewels or other ornamentation, thereby eliminating the need for a ribbon or other wrapper 80 thereover.

The present vertical split 70 in tube 60 and vertical splits 40 in tube collar 30 may be pulled open, and using the expansion resistance present, hold the multiple flower stems F in place. Tube collar 30 and tube 60 may also be easily slipped onto (or over) these flower stems F from the bottom of the assembled arrangement and then pulled up to the highest joining point of the flower stems F, provided the overall diameter of the joined stems F does not exceed the diameter of tube 60.

A stretchable fabric-like sleeve (wrapper) 80 is shown having the same diameter as tube 60 and may completely cover it.

### BRIEF DESCRIPTION OF THE DRAWINGS

Further features, objectives and advantages for these inventions will become clearer when referring to the following detailed description made with reference to the accompanying photographs in which:

FIG. 1 is a side plan view of one embodiment of bouquet holder apparatus according to this invention broken down into its primary components, i.e., a main holder (its dome-shape being representative), a tube collar, a tube wrapper and one representative stemmed flower for inserting into one of the apertures in the main holder;

FIG. 2 is a top perspective view of just the main holder (dome) from FIG. 1 with its plurality of primary apertures 20;

FIG. 3 is a top plan view of the main holder (dome) from FIG. 1;

FIG. 4 is a side plan view taken along lines IV-IV of FIG. 3;

FIG. 5 is a top perspective view of a first alternate embodiment of domed main holder with its plurality of primary apertures 120 and smaller secondary apertures 126;

FIG. 6 is a top plan view of the alternate main holder (dome) from FIG. 5;

FIG. 7 is a side plan view taken along lines VII-VII of FIG. 6;

FIG. 8A is a top view of a first embodiment of aperture/slit 24 according to this invention;

FIG. 8B is a top view of a second embodiment of aperture/slit 123, 124;

FIG. 8C is a top view of a third embodiment of aperture/slit 224;

FIG. 8D is a top view of a fourth embodiment of aperture/slit 324, with optional slits 325;

FIG. 8E is a top view of a fifth embodiment of a gapped aperture/slit 426;

FIG. 8F is a top view of a sixth embodiment of a five-standing aperture/slit 524;

FIG. 9 is a front perspective view of an optional tube collar 30 with slits 40 for allowing extra room for the expansion of flower stems between flower head and tube collar 30. It includes a vertical slit 50 that lets this tube collar expand for the wrapping of stems therein. It also shows a tube 60 as the flower bouquet handle, said tube having a vertical slit 70 that permits expansion for wrapping around gathered stems;

FIG. 10 is a side view of the optional stretchable tube wrapper 80;

FIG. 11 is a side view of a completed flower bouquet using the apparatus of this invention;

FIG. 12A is a top plan view of a first alternative configuration for a cascade-shaped arrangement;

FIG. 12B is a top plan view of a second alternative configuration for a crescent-shaped arrangement;

FIG. 12C is a top plan view of a third alternative configuration for a Hogarth (or S-) curve shaped arrangement;

FIG. 12D is a top plan view of a fourth alternative configuration for a diagonal-shaped arrangement;

FIG. 12E is a top plan view of a fifth alternative configuration for a heart-shaped arrangement;

FIG. 12F is a top plan view of a sixth alternative configuration for a triangular-shaped arrangement;

FIG. 12G is a top plan view of a seventh alternative configuration for an oval-shaped arrangement; and

FIG. 12H is a top plan view of a seventh alternative configuration for a horizontal-shaped arrangement.

### DETAILED DESCRIPTION OF PREFERRED EMBODIMENTS

When referring to the alternate embodiments of main holders (dome-shaped or otherwise), apertures/slits, etc. herein, it is to be understood that common components will be commonly numbered though in the next hundred series.

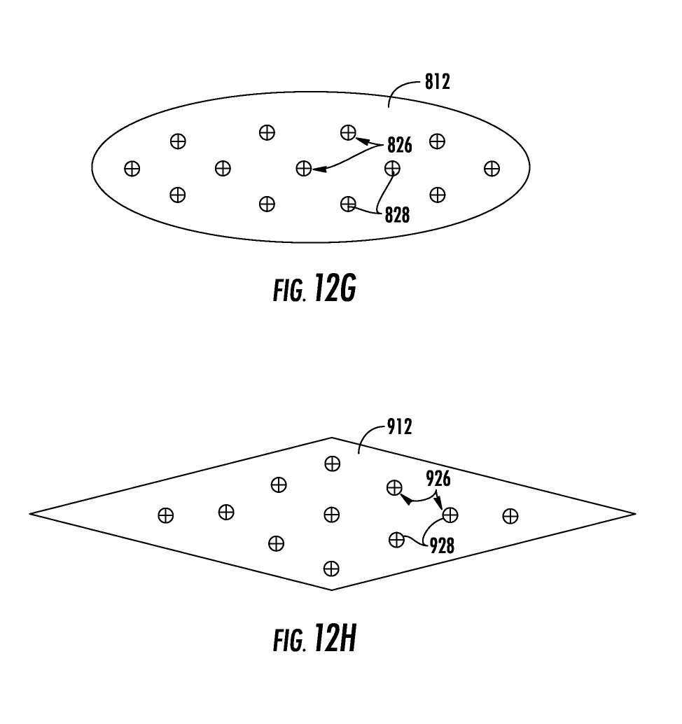

While shown in a round, hemispherical or dome shape, it is to be understood that still other configurations/shapes may be practiced according to this invention. For instance, for a table centerpiece, there may be an elongated bread loaf-shaped, centerpiece flower holder. For still other bride-desired arrangements, pre-shaped apparatus may include a main holder that is; cascade-shaped, like element 212 in FIG. 12A; crescent-shaped like holder 312 in FIG. 12B; Hogarth or S-curve shaped like holder 412 in FIG. 12C; diagonal shaped like holder 512 in FIG. 12D; heart-shaped like holder 612 in FIG. 12E; triangular (or pyramidal)-shaped like holder 712 in FIG. 12F; oval-shaped like holder 812 in FIG. 12G; and/or horizontal-shaped like holder 912 in FIG. 12H. All such alternate configurations include one or more of the various inventive aspects described below.

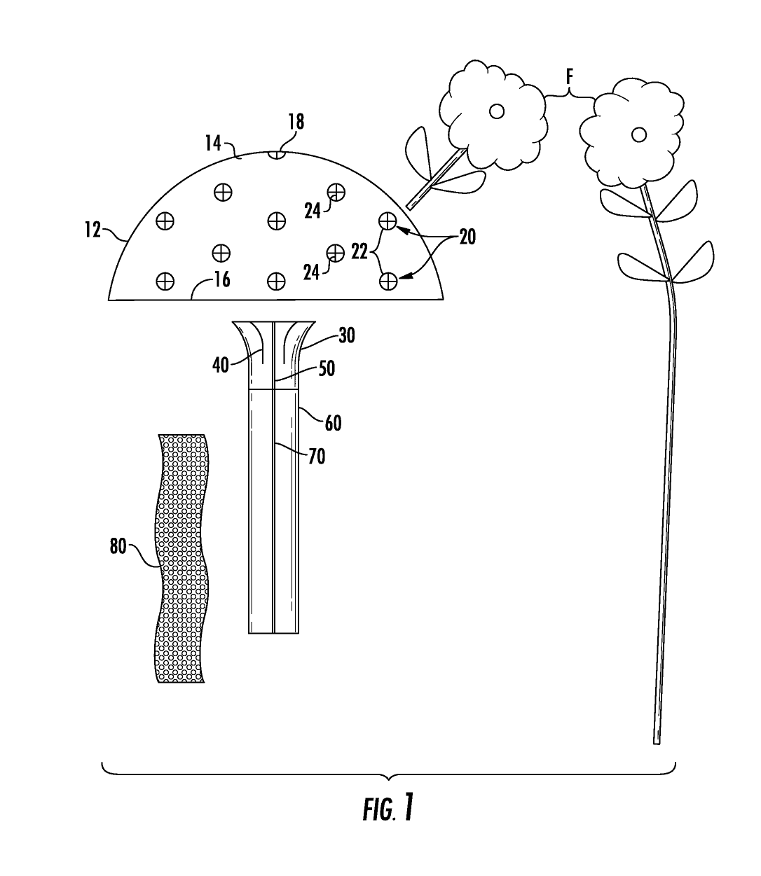

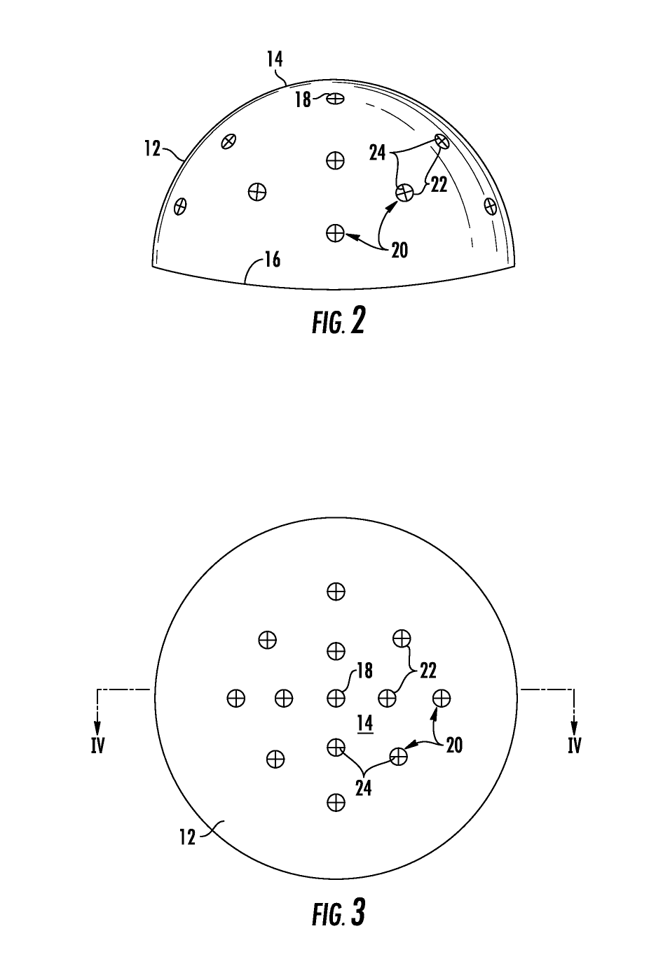

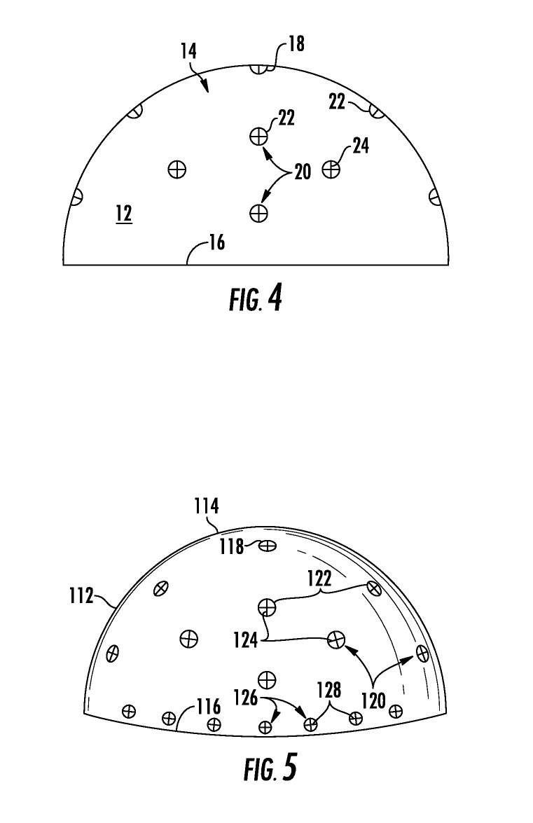

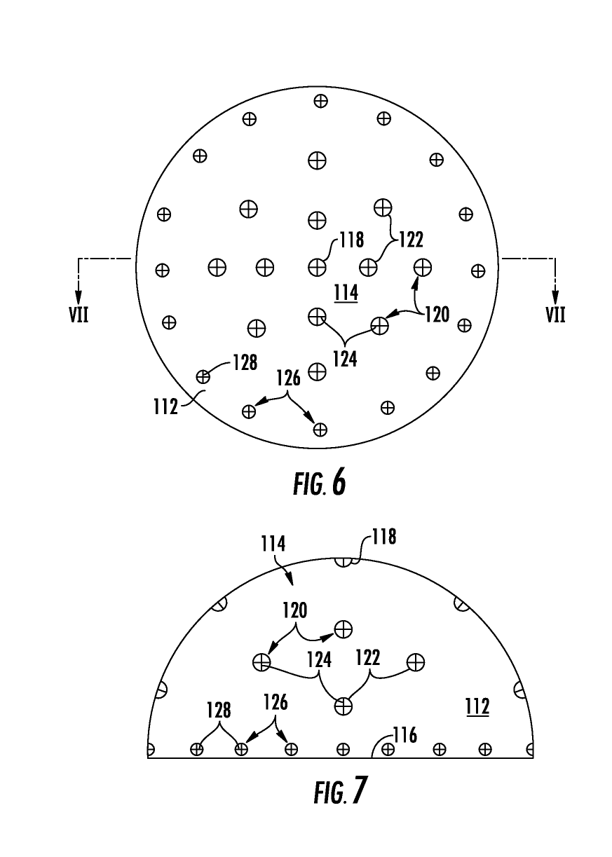

Referring to FIGS. 1 through 4, main holder (dome) 12 of apparatus 10 is configured to have a hemispherical cross-sectional shape, from the top 14 of that dome to its base or lower perimeter/edge 16. Each dome 12 will include a plurality of apertures (or slits) 20, usually inside of a surrounding circular perimeter 22 with a crosscut 24 across the diameter of perimeter 22 in two or more locations of each aperture/slit 20. These apertures/slits 20 are situated a predefined distance from one another, each aperture/slit being capable of holding the stem of a flower F pushed therein. In the case of this preferred dome configuration, there is also an uppermost, central aperture 18.

These apertures/slits 20 should have sufficient flexibility for pulling through materials with one or more leaves attached (intact). The larger leaves might need to be removed, but smaller materials/greens may be pulled through such apertures. This applies to both artificial and fresh flower arrangements.

Main holder 12 is preferably constructed of plastic as that term is used in a generic sense. It could be a polyvinyl chloride PVC, a sufficiently rigid PTFE blend or other composite-like construction. A rigid synthetic plastic is preferred for its construction, with flexible slits/holes or apertures 20. Alternately, main holder 12 may be made from a polycarbonate shell using rubber-like silicone about its apertures 20. To a lesser preferred degree, main holder 12 could be constructed of a non-plastic material such as aluminum provided it is rigid enough to withstand the force of repeatedly pushing or pulling flower stems F (live or artificial or both) through its apertures 20 without collapsing.

During assembly, the heads to the respective flowers F shall come to rest on an uppermost surface of main holder 12. As such, this dome prevents the bunch of flower heads from being placed too high or too low in relation to the one another.

The stems of flowers F that are inserted shall protrude loosely below main holder (dome) 12 while the remaining flowers F get inserted into other apertures/slits within this main holder 12. A first flower F is inserted into the centermost aperture 18, with other flowers F added sequentially, working from the inner circle to the outer rim of the dome all the way down to its lowermost perimeter 16. Except for this centermost first flower F, the user may elect to slightly bend or curve the stem from its flower head to approximately 5″ down. This will help hold all other (subsequent) flower stems in the center of the arrangement.

Excess greenery from the bottom two thirds of each flower stem F may be removed prior to insertion into its aperture 20. Determination of any additional greenery to be removed from the flowers may be made after final assembly, as greenery in the upper third of the stem (just below the main holder 12) will usually provide adequate coverage of bare stems. The purpose of removing the lowest leaves from the respective flowers avoids having these leaves take up unnecessary space within tube 60.

The thickness of the combined stems may be greater than the diameter desired for the bouquet handle. One solution is to first insert all of the flower stems into their apertures 20 before cutting any number of stems to a depth below the top rim of tube collar 30. Then using any floral adhesive, the arranger should secure the cut and loose stem to the tube collar and/or adjacent stems if needed.

Additionally, the area below main holder 12 may be enhanced with a decorative base of tulle, lace, or other fabric that will be secured in place when the tube collar 30 is pushed up to the joining point for all the flower stems. This addition of decorative product (inserted between the tube collar 30 and underside of main holder 12) helps fill in any gaps and assists in camouflaging those sections of flower stems extending below the main holder 12. Slits 40 in the upper half of tube collar 30 may expand to provide additional coverage of any stem extensions from the dome to the common joining point.

Vertical split 50 in tube collar 30 may be used to force (or split open) the tube collar 30. Using the expansion resistance present, it can then wrap and hold the flower stems in place. Alternately, tube collar 30 may be slipped up and over the flower stems F from the bottom of the arrangement. There, it can be pulled/raised to the highest possible joining point of the combined stems provided the overall diameter of these joined stems does not exceed the maximum diameter of tube collar 30 bottom.

Tube 60 can cover the remaining flower stems while further serving as the bouquet handle. A vertical split 70 in tube 60 may be used to force (or split) it open sufficiently for wrapping and holding the flower stems in place using the expansion resistance present. Alternately, tube 60 may be slipped over these stems from the bottom of the arrangement and pulled up to the highest possible point before slipping into the bottom of tube collar 30, if utilized, or pushed to the topmost convergence point of the stems, provided the overall diameter of the joined stems does not exceed the maximum diameter of tube 60.

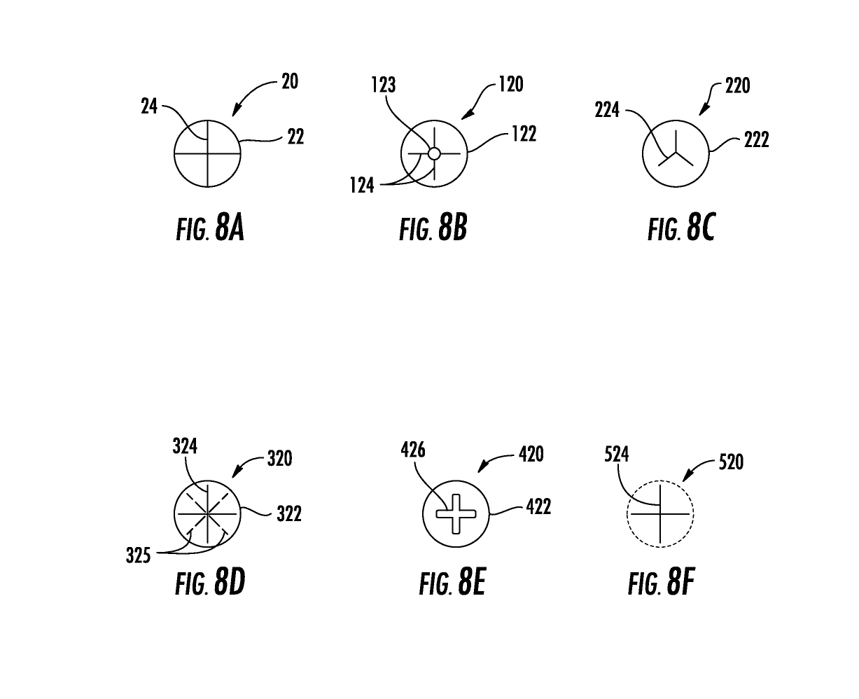

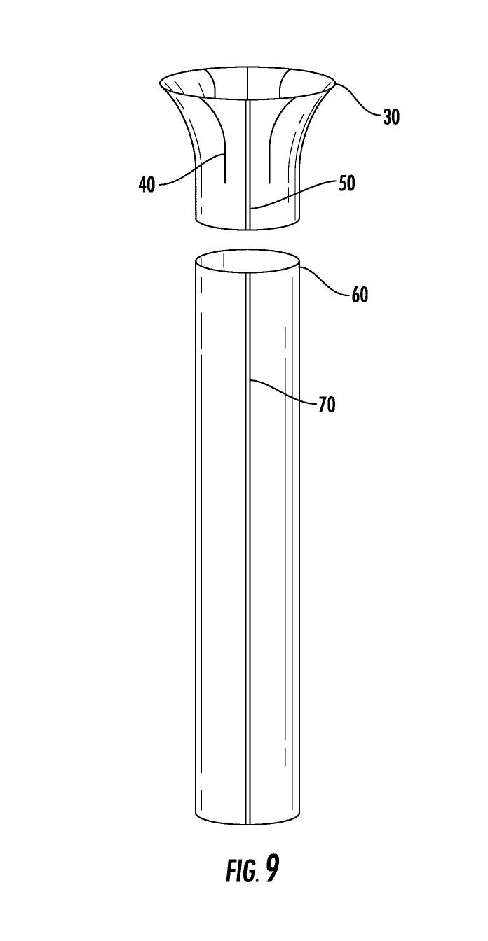

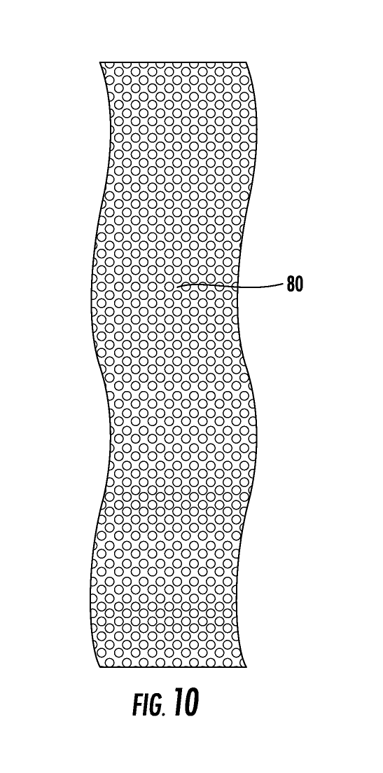

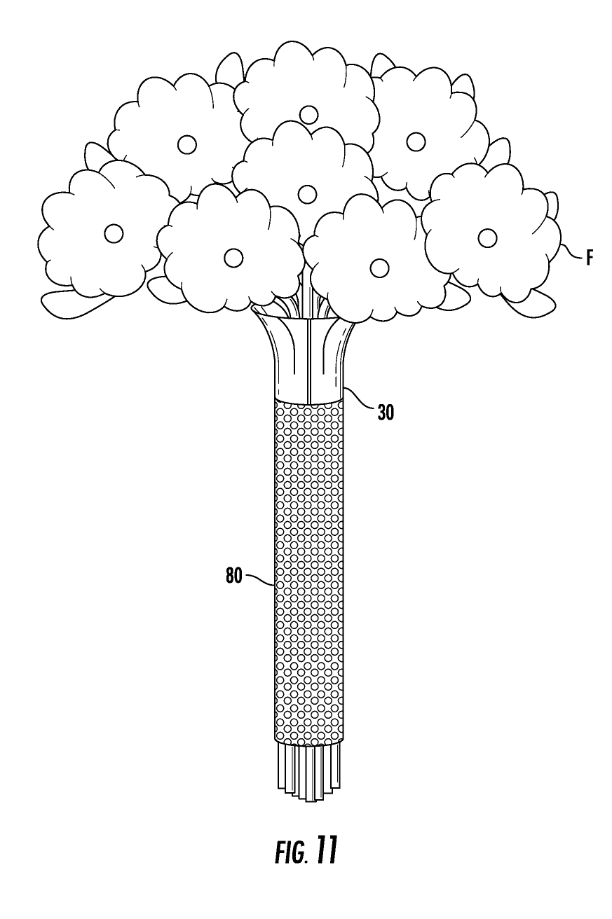

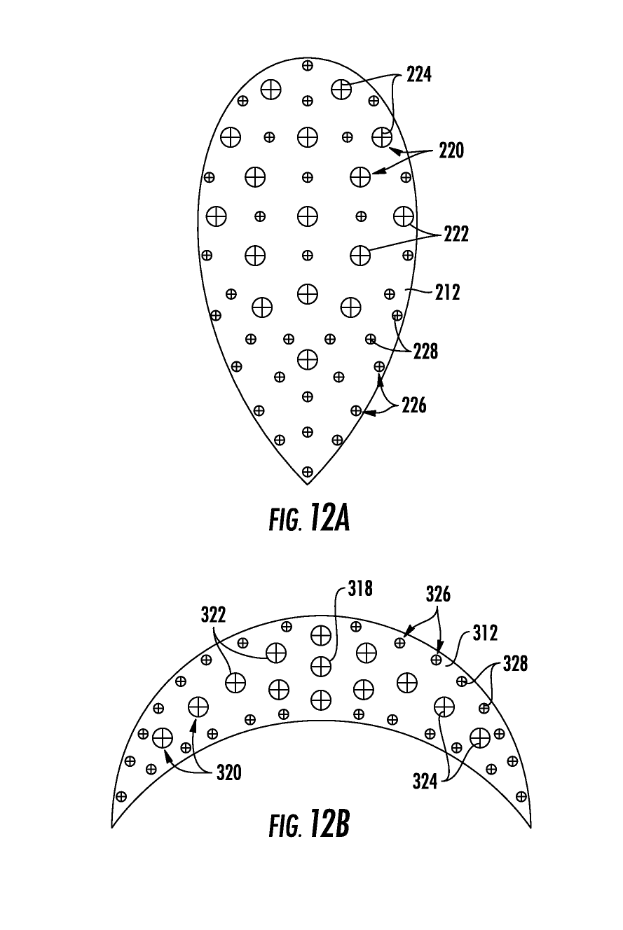

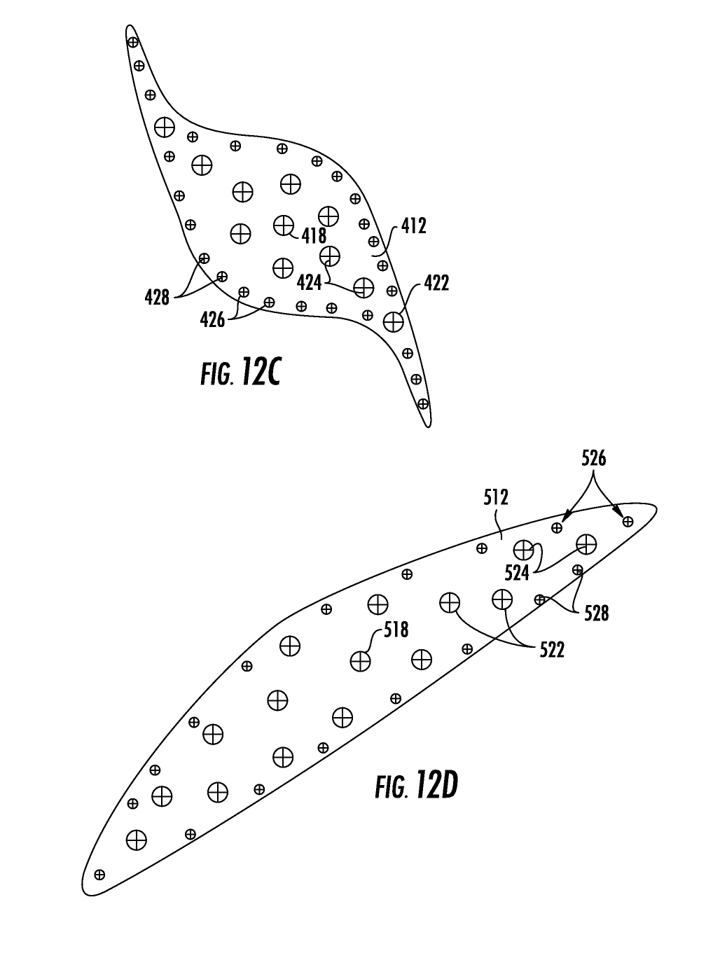

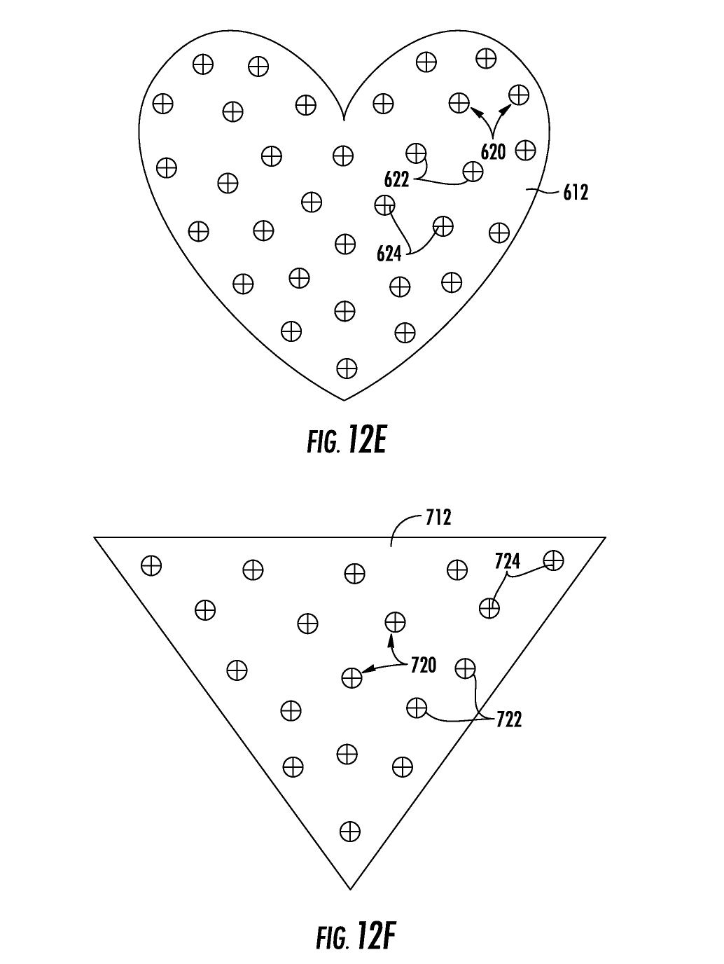

Towards completion of the arrangement, the user will determine if it's necessary to turn the flower heads or fluff the petals to cover any gaps (empty spaces). To incorporate fillers or other secondary or tertiary material, the user may make use of the same apertures as used for the main flower, or incorporate material into a plurality of smaller, secondary apertures shown as element 126 in FIGS. 5 through 7, for example. Furthermore, the apertures/slits, themselves, may assume the standard size and shape (across the full diameter of a circular surround 22, 122, 222, 322, 422, 522, 622 and 722 as shown in the accompanying drawings). Or, as shown in the alternate slit shapes of FIGS. 8B through 8F, these same slits may include: a larger central aperture 123 with cut lines 124 extending outwardly therefrom (FIG. 8B); between three to eight cut lines alone (FIG. 8C depicting a trio of such for representative purposes), none of which extend from circular perimeter to circular perimeter; a plurality of main cut lines 324, with optional additional cuts shown in dotted lines 325 in FIG. 8D; a purposefully gapped set of cut cross-sectional lines, spaced apart as per element 426 in FIG. 8E; and/or a set of cut lines ALONE, element 524 in FIG. 8F, without any “formal” circular perimeter surround. The intent behind any such aperture/slit configuration is to maximize how far the aperture can be spread “open” for the passage of thicker stemmed flowers (live or artificial) therethrough without detrimentally impacting the chance for subsequent removal of flowers and possible reuse of the main holder in another, second flower arrangement. These various aperture/slit configurations should accommodate various flower stem “sizes” without ripping the underlying “holes” too excessively.

A standard dimension for a hand-tied bouquet handle is usually about two hand-lengths (or an average of about 7.5 to 8 inches long). Ideally, tube 60 may be manufactured with one or two break away sections that can be easily removed using perforations built into tube 60. They can provide for an immediate adjustment to the overall height/length of tube 60 as desired.

When using fresh flowers, stems may be purposefully left protruding from the bottom of tube 60 to enable suspension of the assembled bouquet in a water container for maintaining freshness of the arrangement until needed. In some instances, the final bouquet design may leave these protruding stems. But more often, such stems are cut to a blunt and even edge before being encased in a wrapping.

When using artificial flowers, their lower stems may also be left protruding from the bottom of tube 60 for a more “natural” appearance. Otherwise, for both artificial and fresh flowers, excess stem lengths may be trimmed away with wire cutters for artificial flowers and with scissors or a florist's knife for fresh (or live) flower arrangements. A stretchable fabric-like sleeve (wrapper) 80 having about the same diameter as tube 60 may then be used to cover the handle. Manufactured from any number of materials, this wrapper could be provided in any number of colors or styles.

Prior to wrapping tube 60 with stretchable tube sleeve 80 or any other wrapping material, it is important for the arranger/assembler to secure the bottom of stems to tube 60 using OASIS brand Floral Adhesive, acceptable for use on both fresh and artificial materials. After allowing the glue to dry for 24-36 hours, the stretchable sleeve 80 or other wrapping is attached there over.

Other tube 60 wrappers might include ribbon, raffia, tulle, lace and fabric trim. Additionally, tube 60 may be covered with glued-on crystals, pearls, jewels or other material that will match the colors of the event (i.e., wedding colors).

To a less preferred extent, it may be desired (in some instances) to add another piece to the device, namely a snap-in bottom shield (not shown) for beneath the main holder. Like a concave-shaped, salad bowl cover, it would be rigid while also connecting to/about the tube.

It may also be prudent to assist less-experienced arrangers by adding some type of color coding system about the various aperture surrounds (also not shown). In that instance, larger holes may be coded in green surrounds, medium-sized holes in blue and the smallest holes for accessorizing greenery in red surrounded holes.

Having described the presently preferred embodiments, it is to be understood that the invention may be otherwise embodied within the scope of the appended claims below.

What is claimed is:

1. An apparatus for arranging a flower bouquet comprising:
a three-dimensional main holder base that establishes an overall external shape for the bouquet, said main holder base having an upper surface with a plurality of spaced apart apertures, each aperture being capable of having a flower stem inserted therethrough and holding the flower stem in position for forming a part of the bouquet;
a tube collar for situating beneath the main holder base; and
a tube handle for wrapping about a collection of flower stems that have been inserted through apertures in the main holder base.

2. The apparatus of claim 1, which further includes:
a tube wrapper for aesthetically covering the tube handle.

3. The apparatus of claim 1 wherein the main holder base is hemispherical.

4. The apparatus of claim 1 wherein the upper surface of the main holder base has a shape selected from the group consisting of: a dome, a cascade, a crescent, an S-curve, a diagonal, a heart, a triangle, an oval and a horizontal section.

5. The apparatus of claim 1, which is reusable.

6. The apparatus of claim 1 wherein the upper surface of the main holder base includes a plurality of larger slitted apertures and a plurality of smaller slitted apertures.

7. The apparatus of claim 1 wherein at least one of the tube collar and the tube handle is slitted for expanding to hold large quantities of flower stems for the bouquet.

8. The apparatus of claim 1 wherein the flowers are fresh cut, artificial or a combination thereof.

9. The apparatus of claim 1 wherein each aperture includes between three to eight pre-cut slits.

10. The apparatus of claim 1 wherein the bouquet is suitable for use as a wedding bouquet, a nosegay or a table centerpiece.

11. An improved flower bouquet-making apparatus that eliminates the need for: (i) floral design experience; and (ii) floral industry-fastening devices, said bouquet-making apparatus comprising:
a main holder base that: defines an overall shape for a flower bouquet; enables quick and easy insertion of flower stems therethrough; and gathers inserted flower stems therebelow, said main holder base having a plurality of spaced apart apertures, each aperture having at least three pre-cut slits through which a flower stem is inserted and held in place for making the flower bouquet.

12. The apparatus of claim 11, which includes a plurality of large spaced apart apertures and a plurality of smaller spaced apart apertures.

13. The apparatus of claim 12 wherein the large spaced apart apertures and the smaller spaced apart apertures are interspersed about an upper surface of the main holder base.

14. The apparatus of claim 12 wherein the smaller spaced apart apertures are situated about a lower perimeter of the main holder base.

15. The apparatus of claim 11, which is used for holding a plurality of fresh cut flowers.

16. The apparatus of claim 11, which is used for holding a plurality of artificial flowers.

17. The apparatus of claim 13 wherein the main holder base has a shape selected from the group consisting of: a dome, a cascade, a crescent, an S-curve, a diagonal, a heart, a triangle, an oval and a horizontal section.

18. A method for forming anaesthetic hand-held bouquet comprises:
(a) providing a main holder holder base apparatus that defines an overall shape for the bouquet, said apparatus having a plurality of spaced apart apertures with multiple pre-cut slits that enable quick and easy insertion of flower stems therethrough;
(b) inserting individual flower stems into apertures in the apparatus, starting at or near a center point of the apparatus and filling in with additional flower stems outwardly from the center point to an outer perimeter of the apparatus;
(c) encasing lower ends from the inserted flower stems that extend below the apparatus in a tube collar; and
(d) securing the tube collar in a tube holder that functions as a bouquet carrying handle.

19. The method of claim 18, which further comprises:
(e) wrapping the tube holder with a ribbon or fabric cover.

20. The method of claim 18 wherein the apparatus has a shape selected from the group consisting of: a dome, a cascade, a crescent, an S-curve, a diagonal, a heart, a triangle, an oval and a horizontal section.
